(19) United States
(12) Patent Application Publication
(10) Pub. No.: US 2006/0074802 A1
(43) Pub. Date: Apr. 6, 2006

(54) Electronic payment system with rejection option

(76) Inventors: Edward N. Hall, Portland, OR (US); Carl F. Dyess, Beaverton, OR (US)

Correspondence Address: JENNINGS, STROUSS & SALMON, P.L.C., 201 E. WASHINGTON ST., 11TH FLOOR, PHOENIX, AZ, 85004, US

(21) Appl. No.: 11/241,149

(22) Filed: Sep. 30, 2005

Related U.S. Application Data
(60) Provisional application No. 60/614,491, filed on Oct. 1, 2004.

(51) Int. Cl. G06Q 40/00

(52) U.S. Cl. 705/40

(57) ABSTRACT

A system and method for electronic processing of periodic payments such as rent payments is disclosed. Payer tenders an electronic payment through a server interface and funds are transferred to a clearing account. Payee reviews the incoming payments and may accept a payment, in which case, funds are transferred to payee, or reject it, in which case funds are returned to the payer.

### CROSS REFERENCE TO RELATED APPLICATIONS

This Application claims the benefit of priority of U.S. Provisional Application Ser. No. 60/614,491, filed Oct. 1, 2004.

### FIELD OF THE INVENTION

This invention is in the field of electronic payment processing through Internet or network-based interfaces with the participants and a payment clearing service.

### BACKGROUND OF THE INVENTION

Internet-based online payment for goods or services, or payments of installments on a variety of obligations, is common at the present time. For example, a customer may log onto a website maintained by his electric utility, call up a display of his current billing, select a payment method, such as a credit card, debit card or electronic check, enter the appropriate authorizing information, and click “submit.” Funds are transferred and an electronic receipt is displayed, and often a receipt is emailed to the customer. Convenience to the customer and provider is manifest: an immediate payment and receipt are generated without the need of the customer to travel to a service counter maintained by the utility; moreover, these transactions may be processed 24 hours a day, 7 days a week.

The landlord industry, made up of building owners that rent residential or commercial real estate to tenants, can benefit from the convenience and accuracy of a web-based system for payment and collection of rent. While some landlords collect rent directly from tenants, many large-volume building owners depend upon property managers to administer the collection of rents and eviction of non-paying tenants, among other duties.

One characteristic of the landlord-tenant relationship that separates the industry from many others is that acceptance by the landlord of a partial rent payment may afford substantive rights to a tenant with respect to the leased premises. The relationship is governed by state laws. In some states, acceptance of a small part payment engenders a cure period wherein the tenant has up to 30 days to make the balance of the factually overdue rent payment. In some states, acceptance of a tendered late payment automatically waives any penalties and reinstates the tenant relationship in good standing. Residential landlord-tenant statutes in many states, drafted to protect tenants from evictions, offer a variety of tenant rights stemming from the making of part payment or current or overdue past rent.

Because of the possibility of substantive tenant rights upon the landlord's acceptance of a part payment, the landlord industry is not well served by a web-based payment system that automatically takes the tendered funds. It would be useful to have a system whereby the tendered rent payments are electronically confirmed as to funds availability or actually collected, but in which the landlord or his agent has the ability to reject a payment if that payment is incorrect and its acceptance could establish rights adverse to the landlord's interests.

### SUMMARY OF THE PRESENT INVENTION

The present invention is a network or web-based payment processing system particularly useful for landlord property managers in collecting rents. The tenant logs into the system and makes a rent payment in much the same way she would pay other bills online. The funds for a debit card or electronic check are collected and held in an escrow account. Simultaneously, the property manager is sent a message that a payment has been made. The manager logs in at a convenient time and reviews the payments recently made; with a single mouse click she accepts each proper payment, which is then transferred to the landlord's account. Any deficient payments may be rejected with a mouse click, and the manager may type a comment explaining the rejection. When a payment is rejected, the system transfers the tendered funds back to the tenant, and a message advising of the rejection is sent to the tenant.

### BRIEF DESCRIPTION OF THE DRAWINGS

FIG. 1 is a block diagram of the principal components of the payment system.

FIG. 2 is a flow diagram showing the operation of the payment system.

### DETAILED DESCRIPTION OF THE INVENTION

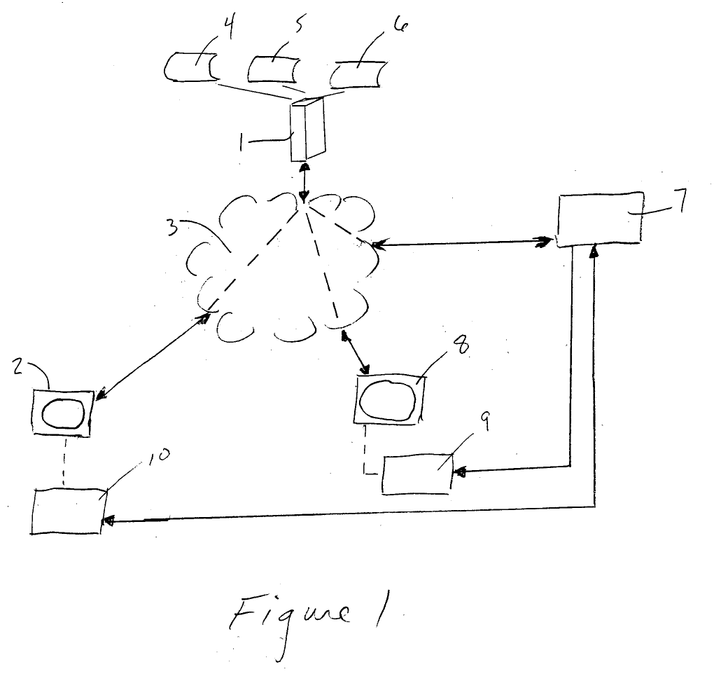

The physical components of one embodiment of the system are shown schematically in FIG. 1. The primary software and records database is located at a server 1. The system may be configured with multiple servers in different locations, interconnected and sharing databases as necessary.

Server 1 includes an interface for use by tenants who will make payments. Tenants communicate with server 1 through their terminals 2 via the Internet 3. The tenant terminal could be a personal computer, a wireless handheld input device, or any device capable of electronic communication with server 1. In a preferred embodiment, the tenant terminal only needs standard web browser software to communicate with the server

Server 1 contains databases of tenant customers and landlord clients 4, interface software for tenants 5 and interface software for landlords 6. Server 1 may also contain transaction processing software capable of interconnecting with financial institutions used by tenants and with drawing funds as authorized by tenants. In the displayed embodiment, however, software on server 1 communicates via the Internet 3 with a transaction processing server of a financial institution 7. The processing service communicates directly with the institutions 10 holding funds of tenants and effects and tracks the movement of funds into the system and then to the landlord's financial institution 9.

Landlord clients, or their property managers, are connected to server 1 via the Internet 3 through landlord terminals 8, which may be browser-enabled personal computers or other devices. The operation of the system is described below.

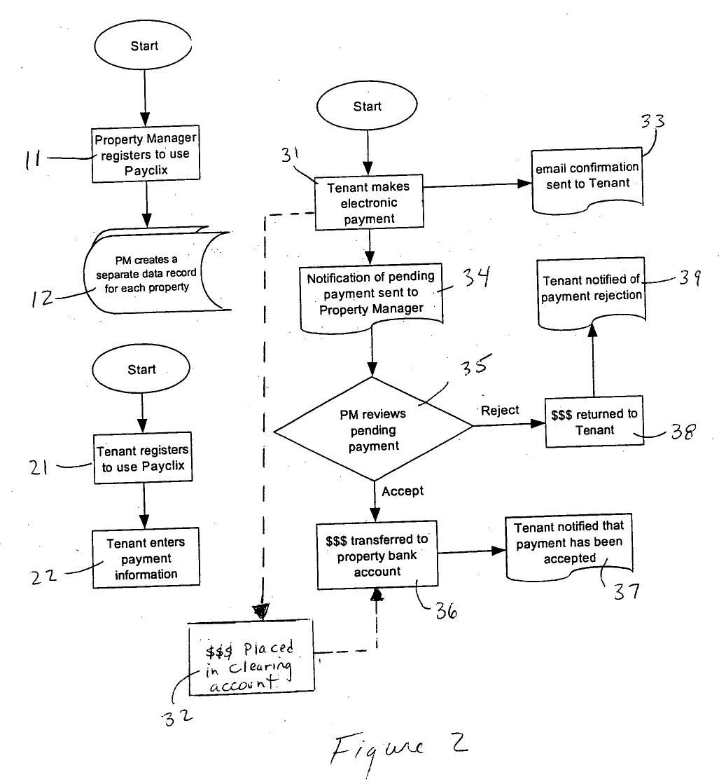

Operation of the system is illustrated in one embodiment in FIG. 2. In the example, the landlord's actions are taken by a property manager. In this embodiment a tenant makes rent payments to a landlord or property manager through a payment processing software system residing on server 1. As noted above, funds transfers could alternatively be handled by a server at a financial institution.

The property manager registers the management company and any properties to be included in the payment processing system 11 and in the course of doing so creates a unique user name with an accompanying password for future system access. Data entry includes contact personnel, email addresses, bank account information, payment acceptance policies, late fees, and other property specific information for each property 12.

A tenant registering with the system creates a unique user name and password. Tenant also adds information identifying the property occupied, the landlord identity, and the financial institution through which tenant will be making payments 22. Tenant may have option of registering for an ‘automatic payment’ option whereby the system will automatically debit their bank account or credit card on a predetermined day each month. Tenant may be advised that payments will incur a convenience fee, which will be added to the amount that they authorize be debited to their account.

When the tenant decides to use the system, the tenant logs in and completes an electronic form to make an electronic rent payment using the system software 31. Payment may be made using credit card, debit card or via an electronic check.

When the tenant approves the payment, the software queries the tenant's financial institution via an Internet transaction to determine if the transaction will be authorized. If the transaction is authorized by the tenant's financial institution, the funds may be transferred immediately into a clearing account maintained by the system 32. Funds may be held in the clearing account until a decision is made by the property manager to accept or reject the proffered payment. Doing so guarantees that if the property manager accepts the payment that sufficient funds will be available to complete the transaction. If the tenant's financial institution denies an authorization, the tenant is informed, the transaction fails and no transfer of funds occurs. If the tenant pays by credit card, the software may communicate with the credit card processor to reserve or hold available the funds until demanded at a later step in the process.

If the credit card or bank debit transaction is authorized by the tenant's financial institution and the funds are transferred into the clearing account, the tenant receives an immediate confirmation of payment received 33 via email, conditional upon acceptance of the payment by the property manager.

The landlord or his designated property manager receives an email notice that tenant has proffered a rent payment 34. The property manager then decides whether or not to accept the proffered payment. This is done by following a link provided in the notification email and signing into the system by supplying the unique user name and password. The property manager is then presented with a web form listing current ‘Pending Payments’ for each property he manages. For each pending payment, the property manager selects, by clicking on a ‘radio button’, his decision to accept or reject the pending payment. A ‘radio button’ is a common web form data control. It has only an ‘on’ or ‘off’ state and when multiple options are available, e.g., ‘accept’ or ‘reject,’ allows only one option to be chosen.

When the choice is made to either ‘accept’ or ‘reject’, the software then follows the appropriate logic path as set out below. It is to be expected that there will be a delay in the period between the time a tenant authorizes a payment and the payment is evaluated for acceptance by the property manager. The property manager, when registering to use the system, may agree that the ‘payment date’ will be the date the tenant makes the payment and not the date the property manager accepts the payment. Thus, a payment made at 11:59 PM on the last day for accepting rents before the due date would not be considered to be late even if the property manager did not make a decision to accept the payment until several days later. This reconciles customary industry practice, where a rent payment is not actually ‘made’ until it is accepted by the property manager, with a system in which the property manager does not wish to deal immediately with a payment the instant it is tendered, but will give retroactive credit to properly tendered payments. The software may, for example, contain numerous edits and warnings to alert users of unusual conditions, e.g., a pending payment still outstanding four days after it was proffered.

If the payment is accepted, the tenant's funds are transferred automatically and electronically into the property manager's property account 36 from the clearing account. If a credit card amount was reserved, the funds may be transferred from the credit card's sponsoring institution. The tenant is notified that payment was accepted 37. At the same time, a payment processing fee agreed to by the property manager is transferred to the operator's bank account.

If the payment is rejected, the funds are returned intact to the tenant 38 along with a reason for the rejection 39. It is then the tenant's obligation to contact the property manager and work out a non-electronic payment scheme to the rent obligation.

Regardless of their decision, the property manager may be given an opportunity to add comments to the decision email before it is sent to the tenant.

The property manager may have access to numerous reports which aid in managing the properties. These reports include listings of previously accepted payments, rejected payments and pending payments. Reports may be ordered by the user in various sort sequences with appropriate arithmetic totals and sub-totals. The disclosed invention is not limited to the example given above. Indeed, the claimed methodology can be applied to virtually all other electronic payment systems where a periodic payment is proffered under the terms of an agreement or contract. The software may also include a rules-based decision matrix, the decision parameters of which can be controlled interactively by the recipient, which would automate the acceptance or rejection of payments without manual intervention.

The claimed methods of this invention may substantially reduce the payment processing difficulties faced by companies who receive periodic payments where the payee can make a payment at an amount lower than is contractually required, the acceptance of which then binds the recipient to certain legal obligations which can be restrictive or undesired.

What is claimed is:

1. A method for transferring electronic payments from a payer to a payee, comprising the steps of:
receiving into an electronic payment system a request for an electronic payment from a payer to a designated payee;
authorizing said payment with payer's financial institution;
receiving funds from said financial institution for an authorized payment from payer;
holding said funds in a clearing account;
querying the payee whether to accept or reject the payment; and
sending funds to an account designated by the payee if payee accepts said payment, or returning funds to the payer's financial institution if payee rejects said payment.

2. The method of claim 1 further comprising sending notification and details to a payer when payments are rejected by payee.

3. The method of claim 1 further comprising sending notification to a payee when a payment is received from a payer.

4. The method of claim 1 further comprising sending notification to a payer when payments are accepted by payee.

5. The method of claim 1 wherein said payment is of the type selected from the group consisting of credit card, debit card, and an electronic check.

6. The method of claim 1 wherein said payer is charged a convenience fee for using said electronic payment system, payable to the operators of said electronic payment system.

7. The method of claim 1 wherein said payee is charged a processing fee for using said electronic payment system, payable to the operators of said electronic payment system.

8. The method of claim 1 further comprising sending notification to the payee when a payment is received from the payer, and sending notification and details to the payer when payments are accepted or rejected by the payee.

9. A system for effecting the transfer of electronic payments from a payer to a payee over a network, comprising:
a server including interface software for communicating between payer and payee and a database of payers, payees and transactions;
a financial transactions clearing means in communication with the server;
means for processing payment submissions from payers by confirming the availability of funds and collecting said funds in a holding account;
means for communicating a tender of payment to an intended payee;
means for permitting the intended payee to review a tendered payment and accept or reject the same;
means for transferring funds electronically to the payee if the tendered payment is accepted;
means for returning funds electronically to the payer if the tendered payment is rejected; and
means for communicating acceptance or rejection of the tendered payment to the payer.

10. The system of claim 9 wherein the network is a global communication network.

11. The system of claim 10 wherein the network is the Internet.
